(19) United States
(12) Patent Application Publication
(10) Pub. No.: US 2012/0118704 A1
(43) Pub. Date: May 17, 2012

(54) Automated packing system

(75) Inventors: Brian Paul Atcher, Louisville, KY (US); Jonathan C. Arnold, Sheperdsville, KY (US)

(73) Assignee: Precision Tool, Die and Machine, Inc.

(21) Appl. No.: 12/926,348

(22) Filed: Nov. 12, 2010

(51) Int. Cl. B65G 43/08

(52) U.S. Cl. 198/572

(57) ABSTRACT

An automated packing system includes a first conveyor conveying goods to a location where the goods are dropped off a belt. A second conveyor is provided beneath the end of the first conveyor so that the goods fall into a box at the area where the second conveyor is located under the end of the first conveyor. Means are provided on the second conveyor to sense the presence of a box aligned under the end of the first conveyor, whereupon an escapement cylinder is activated to retain the box in that position. A controller counts the number of goods placed into the box and when the number is the number that fills the box, the controller releases the escapement cylinder allowing the box to move away from its position under the force of gravity and subsequently the next empty box moves into position under the end of the first conveyor. When the next box arrives at the desired location under the end of the first conveyor, a sensor senses that location and reactivates the escapement cylinder. A sensor senses the presence of goods being conveyed on the first conveyor and also includes a stop cylinder. The sensor enables the controller to count the number of goods that have passed by the sensor and this enables the controller to know when the number of goods that fill a box has passed by.

### BACKGROUND OF THE INVENTION

The present invention relates to an automated packing system. The present invention is intended to be used in association with an existing conveyor sized and configured to move a variety of goods along a belt to a location where those goods can be dropped off the end of the belt as it curves under and circulates back to a point of origin and into a box.

It is known to automate the packing of boxes with goods. However, a need has developed for a system for automating the packing of goods in boxes that simply and effectively accomplishes this task in a repeatable, reliable way. It is with this thought in mind that the present invention was developed.

### SUMMARY OF THE INVENTION

The present invention relates to an automated packing system. The present invention includes the following interrelated objects, aspects and features:

(1) In a first aspect, the present invention contemplates use in association with an existing conveyor that is sized and configured to convey goods to a location where the conveyor ends and the goods may be dropped off a belt as the belt circulates under and back to its source. A second conveyor is provided beneath the end of the first-mentioned conveyor so that when goods are dropped off the first conveyor, they fall into a box at the area where the second conveyor is located under the end of the first conveyor.

(2) In the preferred embodiment, the second conveyor may be angled with respect to the horizontal so that boxes placed thereon may move under the force of gravity. Means are provided on the second conveyor to sense the presence of a box aligned under the end of the first conveyor, whereupon an escapement cylinder is activated to retain the box in that position. A controller counts the number of goods placed into the box and when the number is the number that fills the box, the controller releases the escapement cylinder allowing the box to move away from its position under the force of gravity while the next box, which is empty, moves into position under the end of the first conveyor.

(3) When the next box arrives at the desired location under the end of the first conveyor, a sensor senses that location and reactivates the escapement cylinder.

(4) The existing conveyor is retrofitted with a sensor to sense the presence of parts or goods being conveyed on the first conveyor and also includes a stop cylinder. The sensor enables the controller to count the number of parts or goods that have passed by the sensor and this enables the controller to know when the number of parts or goods that fill a box has passed by. The stop cylinder is operated by the controller to stop the first conveyor between the time a first box has been filled with goods and the time when the next box is moved into position under the end of the first cylinder. A time delay is programmed into the system to accommodate to the logistics of completing filling of a first box, conveying the first box away from the end of the first conveyor, and moving the next box into the position formerly held by the first box. In one aspect, the parts or goods traveling on the first convey are wheels.

As such, it is a first object of the present invention to provide an automated packing system.

It is a further object of the present invention to provide such a system in which parts or goods may be conveyed along a first conveyor and dropped into a series of boxes located on a second conveyor beneath the end of the first conveyor.

It is a yet further object of the present invention to provide such a system in which the boxes on the second conveyor are conveyed through the force of gravity.

It is a still further object of the present invention to provide such a system in which a sensor senses the number of parts or goods such as wheels passing a certain point on the first conveyor so the controller for the system can keep track of the number of parts or goods that have been dropped into a box located beneath the end of the first conveyor on the second conveyor.

It is a still further object of the present invention to provide such a system in which an escapement cylinder is used to retain a box in position under the end of the first conveyor until it is filled with parts or goods, whereupon the escapement cylinder is deactivated to allow the box to move beyond that position and permit the next box to move into that position.

These and Other objects, aspects and features of the present invention will be better understood by those of ordinary skill in the art from the following detailed description of the preferred embodiment when read in conjunction with the appended drawing figures.

### BRIEF DESCRIPTION OF THE DRAWINGS

FIG. 1 shows a schematic front view of the present invention.

FIG. 2 shows a schematic side view of the present invention.

FIG. 3 shows a top view of the present invention.

FIGS. 4-7 show the preferred sequence of operation of the present invention.

FIGS. 8-10 show aspects of the sequence of operation of the lower conveyor that conveys boxes through the force of gravity.

FIG. 11 shows a schematic representation of the pneumatic circuit operating the stop cylinder and escapement cylinder of the present invention.

FIG. 12 shows a schematic representation of a portion of the electronic circuitry of the present invention.

FIG. 13 shows the rest of the electrical circuitry of the present invention.

FIG. 14 shows a portion of the logic of the operation of the present invention.

FIG. 15 shows the remainder of the logic of the operation of the present invention.

### SPECIFIC DESCRIPTION OF THE PREFERRED EMBODIMENT

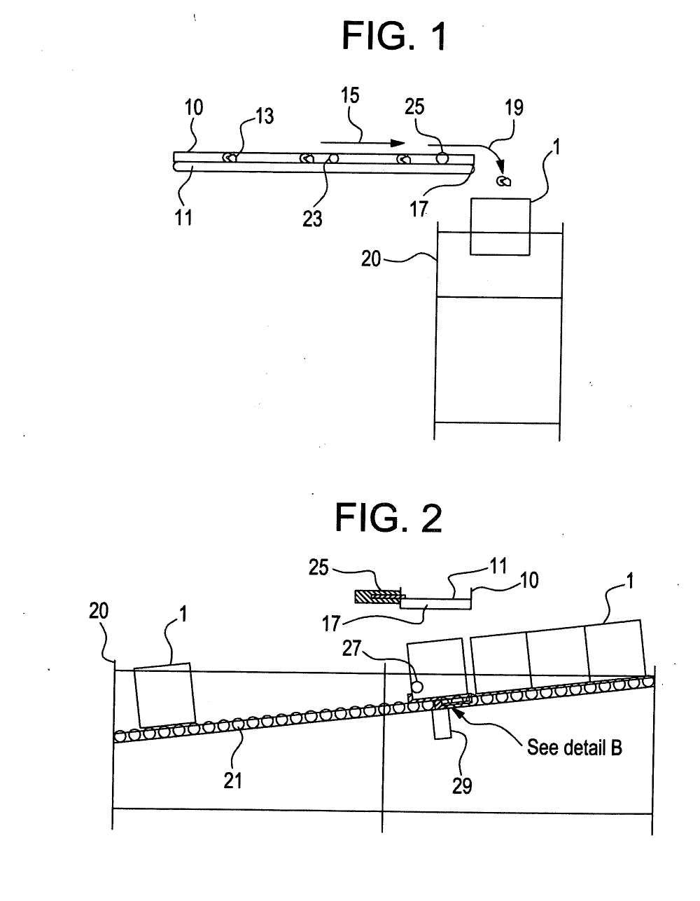

Reference is first made to FIGS. 1 and 2 which show an existing conveyor 10 having a belt 11 on which a series of parts 13 are being conveyed in the direction of arrow 15 to the end 17 of the conveyor 10, whereupon they are dropped off the end of the conveyor 10 in the direction of the arrow 19. In the example shown, the parts 13 are wheels.

With further reference to FIGS. 1 and 2, a second conveyor 20 is sloped with respect to the horizontal as seen in FIG. 2 so that boxes 1 can be moved from right to left in the view of FIG. 2 under the force of gravity. In the preferred embodiment, the conveyor 20 consists of a plurality of rollers 21 that support the boxes 1 and allow them to be conveyed through the force of gravity.

With still further reference to FIGS. 1 and 2, in accordance with the teachings of the present invention, the first conveyor 10 is provided with a parts counter consisting of a photoelectric switch 23 that senses and counts the parts 13 as they pass by the switch 23. As will be described in greater detail hereinafter, the photoelectric switch 23 is electrically connected to a controller 40 that keeps track of the number of parts 13 that have passed the switch 23. The photoelectric switch 23 may be a 24 Volt DC switch that senses light of a particular frequency. The conveyor 10 is also retrofitted with a stop cylinder 25 controlled by the controller and which is activated when a desired number of parts 13 have passed the switch 23, thereby signifying that the number of parts necessary to fill a box 1 has passed by the photoelectric switch 23. As should be understood, a time delay is introduced between the time the last part 13 passes the switch 23 and that part falls off the end 17 of the first conveyor 10 given the distance between the switch 23 and the end 17. In this way, the stop cylinder 25 is not activated until the last part necessary to fill a box 1 has fallen off the end 17 of the conveyor 10.

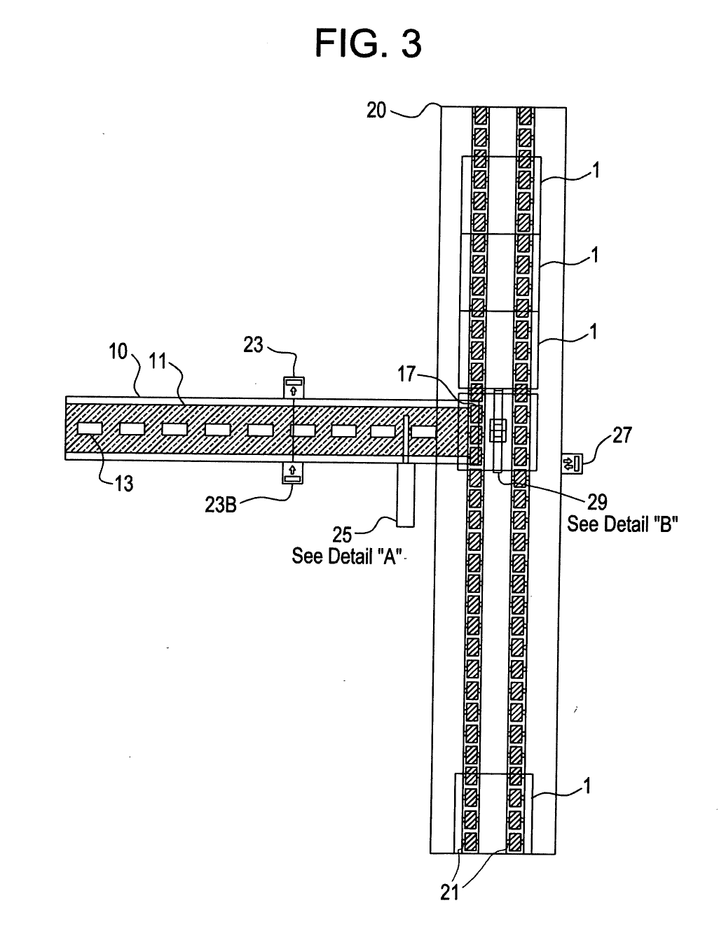

With further reference to FIG. 2, the conveyor 20 includes a box present switch 27 that senses the presence of a box 1 at the location under the end 17 of the first conveyor 10. An escapement cylinder 29 is also provided at that location to be activated through extension of its piston and attached piston rod (FIG. 3) to retain a box 1 in the position shown in FIG. 2 under the end 17 of the first conveyor 10 while parts 13 are filling the box 1. Once the box 1 has been filled as calculated by counting the number of parts 13 passing by the photoelectric switch 23, the escapement cylinder 29 is activated to retract the piston and rod and thereby release the box 1 which is conveyed by the force of gravity on the rollers 21 to the left in the view of FIG. 2, whereupon the next box 1 rolls into position under the end 17 of the first conveyor 10. When the box or container present switch or sensor 27 senses the presence of a box 1 in the correct location, the escapement cylinder is again activated to extend the piston and rod and thereby lock the position of the box 1 under the end 17 of the first conveyor 10 until the correct number of parts has filled the box 1. The switch 27 is preferably a 24 Volt DC photoelectric switch, in diffused mode. The switch emits its own light and looks for the light to be reflected back from an object passing in front of it. When it sees the reflected light, it will switch from an off state to an on state allowing the 24 Volt DC control power to pass through it to the input X0 on the controller, as will be described in greater detail hereinafter. This is how the piston-cylinder arrangement 29 with its cylinders 50 and 55 and pistons 51 and 57 is controlled. With reference, now, to FIG. 3, a top view of the first and second conveyors is shown.

The photoelectric switch 23 is seen to be aligned with a source of light 23B of a specific frequency designed to be sensed by the photoelectric switch 23 so that when the light beam is broken, the result is counting of a part 13 having passed by the switch 23. The stop cylinder 25 is also shown spaced “downstream” of the photoelectric switch 23 and “upstream” of the end of the belt 11.

With further reference to FIG. 3, the conveyor 20 is seen to be disposed at a right angle to the conveyor 10 and includes a plurality of rollers 21 that support the boxes 1 for rolling movement from the top to the bottom in the view of FIG. 3 under the force of gravity. The box present photoswitch 27 is also seen in FIG. 3 as is the escapement cylinder 29.

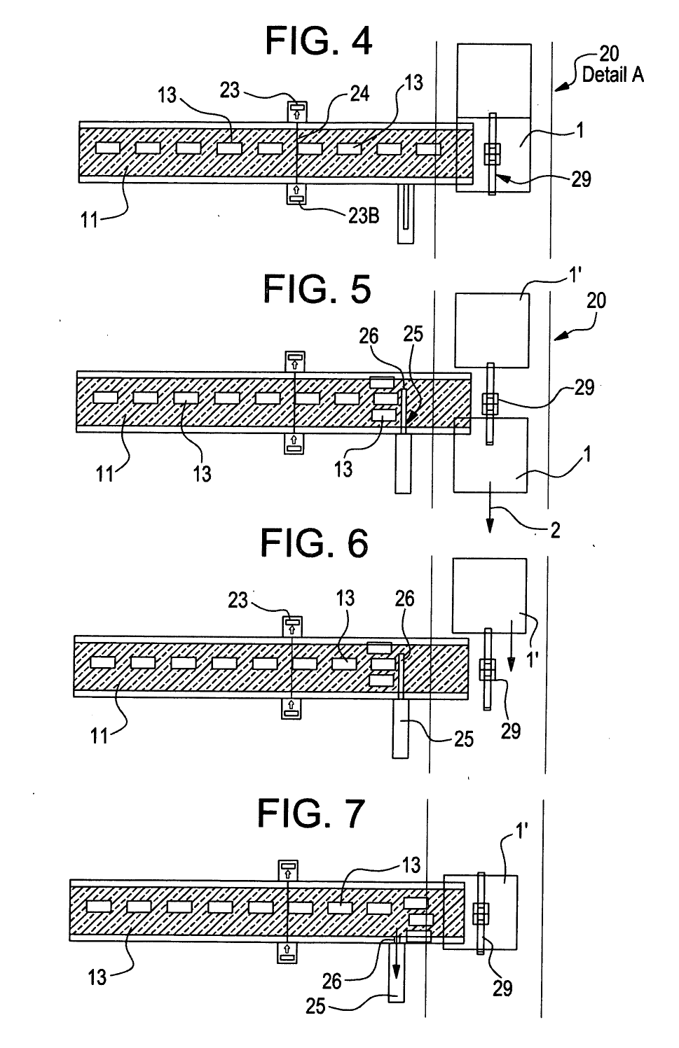

FIGS. 4-7 show details concerning the sequence of operation of the inventive device. FIG. 4 shows the situation when a box 1 is being filled with parts 13 such as wheels. The photoelectric switch 23 is counting the number of wheels 13 that pass by the light beam 24 emanating from the source of light 23B. The piston-cylinder 29 is positioned to retain the box 1 in the position shown in FIG. 4.

With reference to FIG. 5, the box 1 is now full and the piston-cylinder 29 is moved to release the box 1 so that it rolls down the conveyor 20 in the direction of the arrow 2, while the next box 1′ rolls into the place previously occupied by the box 1 as shown in FIG. 4. While all of this is going on, the stop cylinder 25 is activated causing the piston rod 26 to extend, thereby stopping the parts 13 from passing the rod 26.

As shown in FIG. 6, the box 1′ is rolling into position while the stop cylinder 25 maintains the piston rod 26 extended to stop movement of parts 13 which are still being counted by the photoelectric switch 23.

With reference to FIG. 7, the box V is now in position and, as such, the piston-cylinder 29 is activated to lock the position of the box 1′ in the position shown in FIG. 7. Substantially simultaneously, the stop cylinder 25 is activated to retract the piston rod 26, thereby allowing the parts 13 to begin traveling down the conveyor 11 to fill the box V. When the box 1′ is filled, the sequence of FIGS. 4-7 repeats itself, over and over again, so long as there are additional boxes to be filled and parts 13 to fill them.

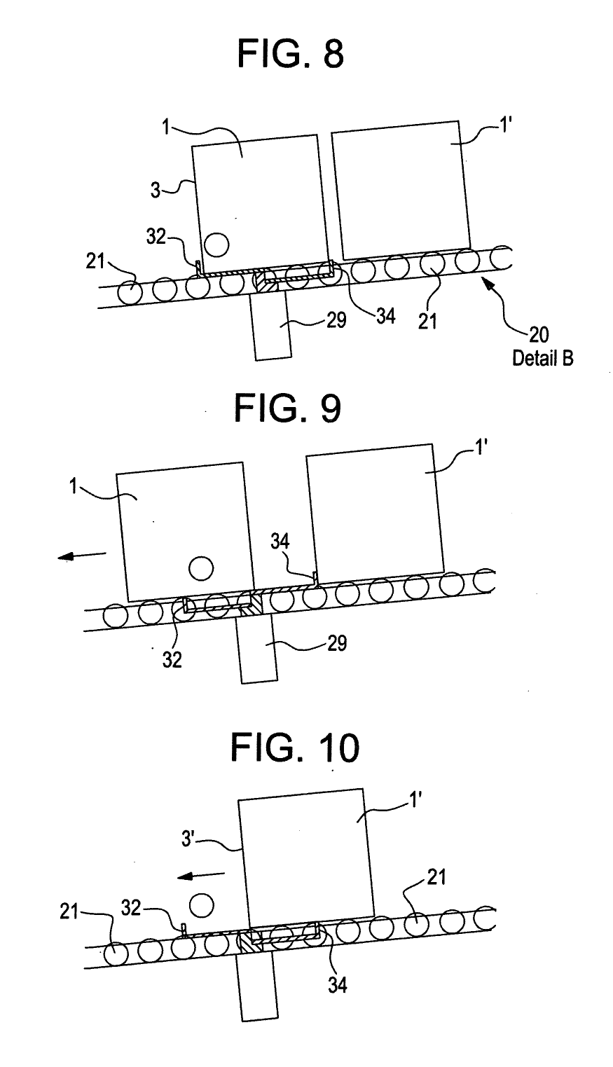

Further details are seen with reference to FIGS. 8-10 which are particularly directed to the conveyor 20 and the boxes 1 and 1′ as examples. With reference to FIG. 8, the box 1 is being held in the position shown by the piston-cylinder arrangement 29. As seen in FIG. 8, associated with the piston-cylinder 29 is a tab 32 that is raised in the extended position shown in FIG. 8 to engage the far wall 3 of the box 1 to prevent it from moving in the left-hand direction in the view of FIG. 8. At the same time, a tab 34 is lowered in the retracted position shown in FIG. 8.

With reference to FIG. 9, when the box 1 has been filled, the piston-cylinder 29 is activated to lower the tab 32 to a retracted position to thereby allow the box 1 to move in the left-hand direction in the view of FIG. 9 while, at the same time, the tab 34 is raised to an extended position to retain the position of the box 1′ until the box 1 has completely gone out of the way of alignment with the conveyor 10 (not seen in FIG. 9).

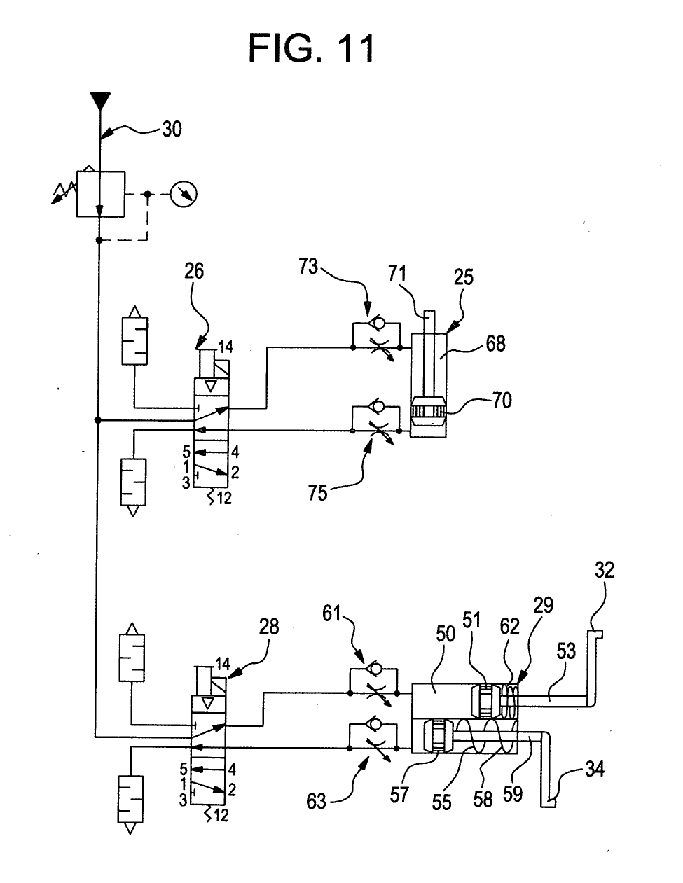

With reference to FIG. 10, once the box 1 is out of alignment with the conveyor 10, the tab 32 is again raised and the tab 34 is lowered to allow the box 1′ to move under the force of gravity on the rollers 21 in the left-hand direction of FIG. 10 until the wall 3′ of the box 1′ engages the tab 32 so that it assumes the position previously assumed by the box 1.

The operation of the tabs 32 and 34 is better understood with reference to FIG. 11. There, the piston-cylinder arrangement 29 is seen at the lower portion of the figure. As seen there, the piston-cylinder 29 consists of a first cylinder 50, a piston 51 within the cylinder 50 and having a piston rod 53, and a second cylinder 55 within which a second piston 57 rides, to which is attached a piston rod 59. A five port reversing valve 28 controls the extension and retraction of the piston rods 53 and 59 through motion of the pistons 51 and 57, respectively. The five port reversing valve 28 conveys air to the cylinders 50 and 55 via check valve-restrictor arrangements 61 and 63, respectively. The pistons 51 and 57 are spring biased in the left-hand direction in the view of FIG. 11. In essence, in one position of the five port reversing valve 28, the piston 51 moves to the right in the view of FIG. 11 under the force of air pressure within the cylinder 50, while the piston 57 moves to the left in the view of FIG. 11 through release of air pressure within the cylinder 55 and operation of spring 58. In a second position of the four port reversing valve 28, the reverse occurs. In particular, the piston 57 moves to the right in the view of FIG. 11 by virtue of air pressure applied to the left-hand side of the piston 57 within the cylinder 55. At the same time, the piston 51 moves to the left in the view of FIG. 11 under a spring biasing force of spring 62. The piston rod 53 is connected to the tab 32 and the piston rod 34 is connected to the tab 34.

With further reference to FIG. 11, the escapement cylinder 25, otherwise described as a locking cylinder, includes a piston 70 with a piston rod 71 that extends across the conveyor belt 11 as shown, for example, in FIGS. 5 and 6. The five port reversing valve 26 controls extension and retraction of the piston rod 71 via the check valve-restrictor arrangements 73 and 75. In essence, in one position of the four port reversing valve 26, air pressure is supplied to the cylinder 68 below the piston 70 in the view of FIG. 11, so that the piston rod 11 is moved upwardly corresponding to its position in FIGS. 5 and 6. In a second position of the four port reversing valve 26, air pressure is supplied in the cylinder 68 above the piston 70 to move the piston rod 71 downwardly corresponding to its position in the view of FIGS. 4 and 7.

As understood by those skilled in the art, in a five port reversing valve, in the first position of the valve, air is supplied under the cylinder to move its piston in a first direction. In the second position of the four port reversing valve, air is supplied on the opposite face of the piston to move it back toward the first position. The valves 26, 28 are spring biased to one position and may be moved to another position electrically by means including a solenoid as is well known.

The operation of the pneumatic circuit 30 including the five port reversing valves 26 and 28 is controlled by the controller as will be described in greater detail hereinafter.

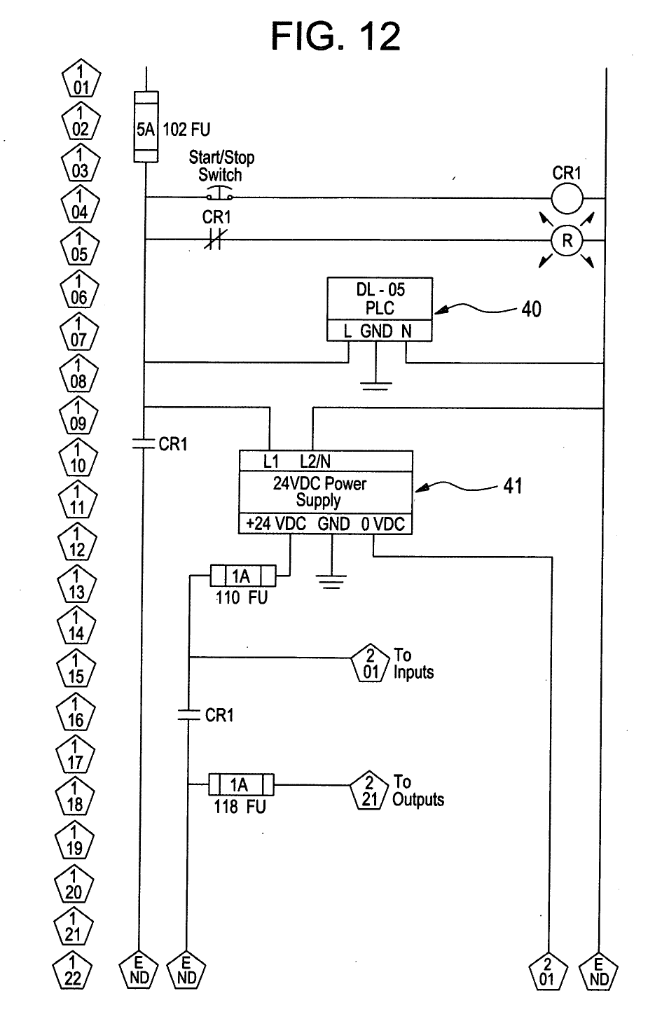

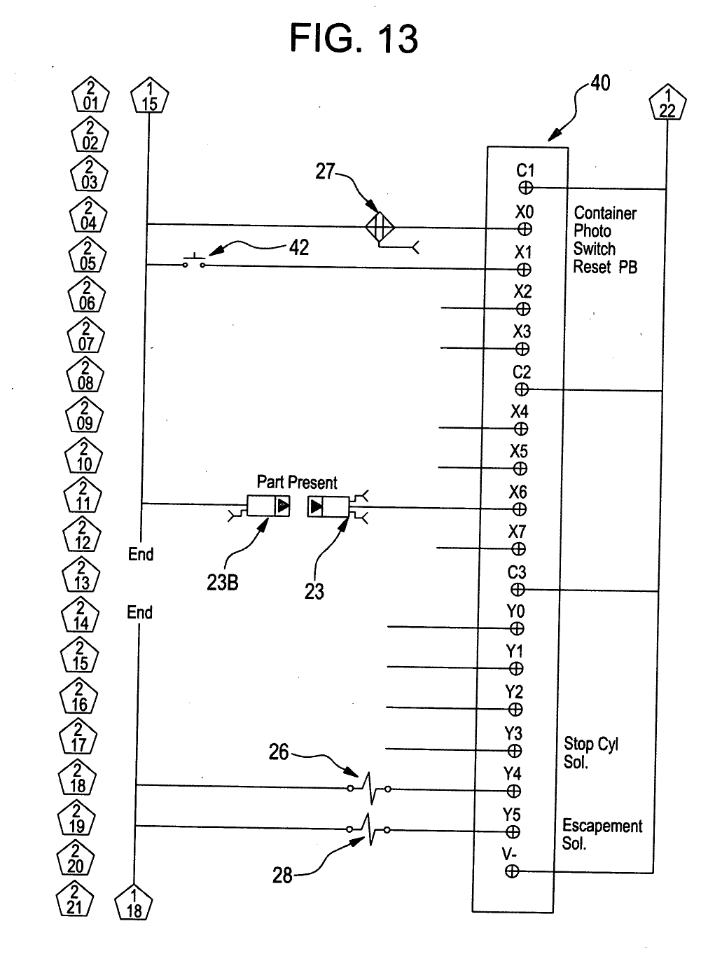

Reference is now made to FIGS. 12 and 13 which show the electrical circuitry of the present invention. The controller is designated by the reference numeral 40. With reference to FIG. 13, the control valve for the stop cylinder 25 is designated by the reference numeral 26, and the control valve for the escapement piston-cylinder 29 is designated by the reference numeral 28. The photoelectric switch 23 is also seen in FIG. 13. A power supply 41 preferably generating 24 volts DC is employed in the system. The sensor 27 is also seen in FIG. 13.

In the operation of the circuitry shown in FIGS. 12 and 13, electrical signals are conveyed to the controller 40 from the photoelectric switch 23 and the box present photoelectric sensor 27. Responsive to those signals, the controller 40 sends signals to control operation of the stop cylinder 25 and the escapement piston-cylinder 29 as also explained above. In sequence, the operation is as follows:

With the first conveyor 10 operating, parts (wheels in the example shown) 13 are sequentially placed on its belt 11, and they are conveyed in the direction of the arrow 15 in FIG. 1 toward the end 17 of the conveyor 10. As the parts 13 pass the photoelectric switch 23, as each part 13 passes the switch 23, the switch 23 sends a signal to the controller 40 which has an internal counter that counts the number of parts that have passed the switch 23. The controller 40 is preprogrammed in a manner well known to those skilled in the art with the number of parts necessary to fill a box 1.

When the number of parts necessary to fill a box 1, as preprogrammed in the controller 40 has passed the switch 23, a preprogrammed time delay is activated. The time delay is set for the amount of time it takes for a part 13 to travel from the switch 23 to the end 17 of the first conveyor 10. Once that time period has elapsed, and the last part 13 has fallen into the box 1, the controller 40 activates the valve 26 of the stop cylinder 25. The stop cylinder 25 when activated by pressurized air flowing through valve 26 extends its piston and piston rod and stops the flow of parts 13 over the end 17 of the first conveyor 10.

Once the last part 13 has fallen into the box 1 with reference to FIGS. 8-10, the controller 40 activates the valve 28 of the escapement piston-cylinder and the valve opens to allow pressurized air to enter the escapement cylinder retracting its piston and piston rod and releasing the box 1 located under the end 17 of the first conveyor 10, whereupon, through the force of gravity, the box 1 travels in the left-hand direction in the view of FIG. 2 on the rollers 21. As explained above with reference to FIGS. 8-10, the next box 1 moves under the force of gravity toward the position where the previous box was previously held after a slight delay to permit the first box to move completely away from conveyor 10. When the box present photoelectric switch 27 senses the presence of the next box, it sends a signal to the controller 40 which activates the valve 28 of the escapement piston-cylinder 29 to extend its piston and piston rod and lock the position of the box 1 under the end 17 of the first conveyor 10. This operation is described in more detail above with reference to FIGS. 8-10.

Once this has occurred, after a short time delay, the controller 40 activates the valve 26 of the stop cylinder to retract its piston rod 71 and allow the flow of parts 13 along the first conveyor 10 to resume. When this occurs, the sequence of events as explained above repeats itself over and over again as each box 1 is conveyed into position, filled, and then conveyed beyond the location below the end 17 of the first conveyor 10.

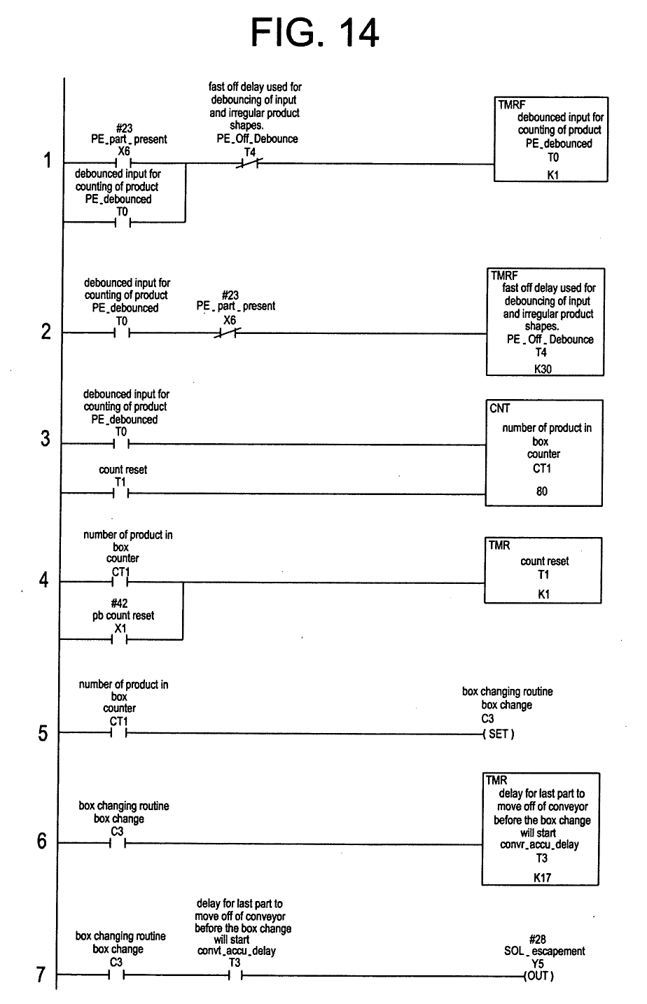

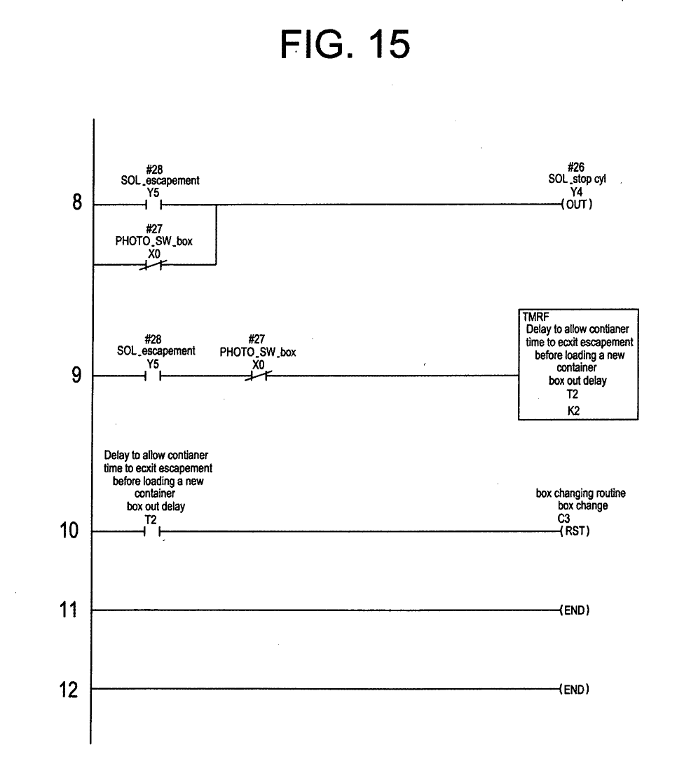

The controller is preferably a micro brick PLC powered by 110 VAC with 8 DC inputs and 6 DC outputs. It may use RLL or RLL Plus programming language to run the program as explained hereinafter with reference to FIGS. 14-15.

The sensors 23 and 27 are powered by 24 Volts DC. With reference to FIG. 13, wire number 1131 provides 24 Volts DC and wire number 1122 shows 0 Volts DC (ground). This voltage is supplied by the power supply 41 (FIG. 12). The sensors are of a type PNP so that when turned on, they pass the 24 Volts DC from the wire number 1131 (FIG. 13) to the controller 40 (FIG. 12) input that is connected to X0-X7 (FIG. 13). The inputs are connected internally in the controller 40 to a common circuit (c1, c2 and c3 on FIG. 13) that completes an internal circuit turning on the input (x0-x7). The outputs are sinking 24 Volts DC, meaning the outputs Y0-Y5 provide the 0 Volts DC necessary to complete the circuit to solenoids used to actuate the five port reversing valves 26 and 28.

With reference to FIGS. 14 and 15, the logic of operation of the inventive system will now be described. In this description, the correlation is made between the numbered paragraphs set forth below and the numbers 1-5 on the left-hand side of FIG. 14, and the numbers 6-12 on the left-hand side of FIG. 15. The explanation is as follows:

(1) With reference to FIG. 14, at number 1, the part present timer Tø turns on after the part present sensor X6, corresponding to reference numeral 23, has been on for longer than 0.01 seconds and turns off by the timer T4.

(2) Timer T4 turns “on” if X6 is off for longer than 0.3 seconds while T0 is still on. Lines 1 and 2 ensure that sensor X6 is a good solid “on” or “off” (debounced) before the program will consider any changes in its outputs.

(3) CT1 is the counter for the parts going into the box. When T0 is turned on, it will increase the accumulated count on CT1. CT1 counter has a preset of 80 (this is how many parts are needed to fill the container). When the count has reached 80, CT1 will be turned on. T1 will reset the number in CT1's accumulator back to 0.

(4) T1 is CT1's reset. It is turned on by pushing button X1 (#42 on FIG. 13), or by CT1 reaching its preset (80). T1 must be energized 0.1 seconds before T1 will turn “on.” This timing delay is used to prevent accidental pressing of X1.

(5) CT1 “sets” bit C3 “on.” C3 when “on” enables the box changing logic.

(6) Timer T3 is a delay to allow the last counted part to move off the conveyor before the box is allowed to move. Timer is enabled by C3.

(7) After timer T3 is completed, output Y5 (escapement valve #28) is activated, allowing the box to move down the second conveyor (#20). See FIG. 5.

(8) Output Y4 (stop cylinder #26) is energized whenever escapement is energized, or whenever X0 (photoswitch #27) is not on. X0 is “on” when there is a box 1 in place under the conveyor 10. If no box is in place, for whatever reason, the piston rod 71 will be extended preventing parts from moving off first conveyor (#10). An example of this is shown in FIG. 6.

(9) Timer T2 is a delay enabled by Y5 (escapement valve 26) being on, and X0 (photoswitch #27) being off. This delay is used to ensure that the box has moved beyond the escapement. This can be called a “debounce” of X0.

(10) After delay of T2, box change procedure C3 is reset to “off.” This will turn “off” T3, which turns “off” escapement valve Y5. See FIG. 6.

(11) At the end of the time period programmed into the timer T2, the change bit C3 is reset ending the box change procedure until the current box is filled, whereupon the same procedure is repeated.

(12) At this point, the entire sequence has been completed.

In the preferred embodiment of the present invention, the second conveyor 20 includes Trilogiq tubing, rollers and fittings in its construction. This conveyor is gravity fed and has the controller 40 electrically connected to the sensors that allow operation. The dimensions of the conveyor 20 are determined by the size of the boxes to be conveyed thereon.

As such, an invention has been disclosed in terms of a preferred embodiment thereof which fulfills each and every one of the objects of the invention as set forth hereinabove, and provides a new and improved automated packing system of great novelty and utility.

Of course, various changes, modifications and alterations in the teachings of the present invention may be contemplated by those of ordinary skill in the art without departing from the intended spirit and scope thereof.

As such, it is intended that the present invention only be limited by the terms of the appended claims.

1. An automated packing system, comprising:
a) a first conveyor having a first end and a second end, said first conveyor conveying items from said first end to said second end;
b) a second conveyor having a first end and a second end, at least a portion of said second conveyor, between its first end and second end, being under said second end of said first conveyor, and said second conveyor conveying containers from its first end to its second end;
c) said first conveyor including:
i) a counter counting a number of items passing said counter; and
ii) a stop device stopping movement of items on said first conveyor responsive to sensing said number of items being a desired number;
d) said second conveyor including:
i) a container present sensor that senses presence of a container at said portion of said second conveyor;
ii) a locking mechanism releasably retaining a container at said portion of said second conveyor; and
e) a controller controlling operation of said system, said controller receiving signals from said counter and, responsive to receiving signals that said desired number has been achieved, activating said stop device to stop movement of said items, said controller responding to said desired number being achieved and releasing said locking mechanism to allow a first container to move away from said portion of said second conveyor and permit a second container to move to said portion of said second conveyor.

2. The system of claim 1, wherein said second conveyor is rotated with respect to said first conveyor so that only said portion is under said second end of said first conveyor.

3. The system of claim 2, wherein said second conveyor is angled with respect to a floor or ground surface such that said containers move under force of gravity.

4. The system of claim 3, wherein said second conveyor comprises a plurality of spaced rollers.

5. The system of claim 1, wherein said counter comprises a photoelectric switch.

6. The system of claim 5, wherein said stop device comprises a rod extendable across said conveyor to physically block movement of items.

7. The system of claim 1, wherein said stop device comprises a rod extendable across said conveyor to physically block movement of items.

8. The system of claim 7, wherein said stop device is located between said counter and said second end of said first conveyor.

9. The system of claim 8, wherein said rod is attached to a piston contained within a cylinder, said piston movable between positions extending and retracting said rod responsive to signals from said controller.

10. The system of claim 1, wherein said container present sensor comprises a photoelectric switch.

11. The system of claim 10, wherein said locking mechanism comprises a tab movable between a first extended position at which said tab holds a container at said portion of said second conveyor, and a second retracted position at which said container can move toward said second end of said second conveyor.

12. The system of claim 11, wherein said tab comprises a first tab, and further including a second tab adjacent said first tab, said second tab moving to a first extended position when said first tab is moved to its second retracted position and said second tab moving to its second retracted position when said first tab is moved to its first extended position.

13. The system of claim 12, wherein said first and second tabs are connected to respective piston rods connected to respective pistons received in respective cylinders.

14. The system of claim 12, wherein in said first extended position of said second tab, said second tab prevents a container from moving to said portion of said second conveyor until another container has left said portion of said second conveyor.

15. The system of claim 13, wherein in said first extended position of said second tab, said second tab prevents a container from moving to said portion of said second conveyor until another container has left said portion of said second conveyor.

16. The system of claim 1, wherein said containers comprise boxes.

17. An automated packing system, comprising:
a) a first conveyor having a first end and a second end, said first conveyor conveying items from said first end to said second end;
b) a second gravity-operated conveyor rotated with respect to said first conveyor and having a first end and a second end, at least a portion of said second conveyor, between its first and second end, being under said second end of said first conveyor, and said second conveyor conveying containers from its first end to its second end;
c) said first conveyor including:
i) a photoelectric counter counting a number of items passing said counter; and
ii) a stop device located between said counter and said second end of said first conveyor and stopping movement of items on said first conveyor responsive to sensing said number of items being a desired number, said stop device comprising a rod extendable across said conveyor to physically block movement of items;
d) said second conveyor including:
i) a photoelectric container present sensor that senses presence of a container at said portion of said second conveyor;
ii) a locking mechanism releasably retaining a container at said portion of said second conveyor, said locking mechanism comprising a tab movable between a first extended position at which said tab holds a container at said portion of said second conveyor, and a second retracted position at which said container can move toward said second end of said second conveyor; and
e) a controller controlling operation of said system, said controller receiving signals from said counter and, responsive to receiving signals that said desired number has been achieved, activating said stop device to stop movement of said items, said controller responding to said desired number being achieved and releasing said locking mechanism to allow a first container to move away from said portion of said second conveyor and permit a second container to move to said portion of said second conveyor.

18. The system of claim 17, wherein said tab comprises a first tab, and further including a second tab adjacent said first tab, said second tab moving to a first extended position when said first tab is moved to its second retracted position and said second tab moving to its second retracted position when said first tab is moved to its first extended position.

19. The system of claim 18, wherein said first and second tabs are connected to respective piston rods connected to respective pistons received in respective cylinders.

20. The system of claim 19, wherein in said first extended position of said second tab, said second tab prevents a container from moving to said portion of said second conveyor until another container has left said portion of said second conveyor.
